(19) United States
(12) Patent Application Publication
(10) Pub. No.: US 2020/0002901 A1
(43) Pub. Date: Jan. 2, 2020

(54) Method of Producing an Asphalt Pavement and Supply Arrangement for Supplying Asphalt Pavement

(71) Applicant: ADELO AB, Bollebygde (SE)

(72) Inventor: Conny ANDERSSON, (SE)

(73) Assignee: ADELO AB, Bollebygde (SE)

(21) Appl. No.: 16/489,085

(22) PCT Filed: Feb. 28, 2018
(86) PCT No.: PCT/EP2018/054877

§ 371 Date: Aug. 27, 2019

(30) Foreign Application Priority Data
Feb. 28, 2017 (SE) 1750213-9

(51) Int. Cl. E01C 19/48; E01C 19/08; E01C 19/16; B01F 9/10; B01F 13/00

(52) U.S. Cl. CPC E01C 19/48; E01C 19/08; E01C 19/16; B01F 2215/0063; B01F 13/0037; E01C 2301/02; B01F 9/10

(57) ABSTRACT

In a method of and an apparatus for improving the quality of an asphalt pavement, the asphalt is charged in a supply arrangement (2) adapted to be fitted in an inlet space (11) of a road finishing machine (1). The supply arrangement comprises a rotary vessel (3) in the shape of a truncated cone with a top inlet (30) and a smaller bottom outlet (31). The rotary vessel (3) has internal irregularities (32) for homogenizing the asphalt as to particle size and temperature. Preferably a distributing device (9) including at least one dividing member (93) and a rearrangement device (95) is also used, having the at least one dividing member (93) extending transversely over the belt conveyor (12) under the bottom outlet (31) to divide the flow of asphalt into layers, on top of one another, and the rearrangement device (95) to optimize form and feeding.

### FIELD OF INVENTION

The present invention relates to an apparatus and a method of improving the quality of an asphalt pavement.

In the present context, the term “asphalt” is intended to mean a mixture consisting of mineral aggregate bound together with asphalt (bitumen).

### BACKGROUND OF THE INVENTION

Upon asphalting of a surface, homogeneousness is important, since it is the worst parts that initiate maintenance measures. In practice, it is impossible to improve the quality of an asphalt pavement at ambient temperature. Thermographic photographing reveals segregation problems, which may be caused by the asphalt plant, the transport of the asphalt out on the road, or practical measures in connection to the change from one lorry batch to the next one.

U.S. Pat. No. 6,122,601 (Swanson et al.) discloses a compacted material density measurement and compaction tracking system, namely a two-component system to obtain uniform density of compacted materials and track the compaction of the materials. The first component provides an automated, real-time compaction density meter and method of use to measure the density of the compacted material. The second component provides a Geographic Information System (GIS) for tracking compaction of a surface at specific locations. These two components combined provide a system to measure the density of the compacted material and record the location of each density measurement. The can be utilized for many compaction operations, such as the roller compaction of concrete, pavement, soil, landfills, and asphalt pavements.

From WO2007106033 there is known a system for preventing separation of asphalt compositions, comprising separation preventing compartments arranged in a silo, intended for loading of asphalt onto vehicles, separation preventing compartments intended to be arranged to a deck of a vehicle to be loaded with asphalt, and separation preventing means arranged in a hopper of a paver to be loaded with asphalt from a vehicle. This design is relatively complex and may cause jamming problems.

Further, US 2014/0308074 (Rutz et al.) discloses a road finishing machine with a thermographic device releasably fixed to a portion of the machine for recording a georeferenced thermographic data record of at least one region of a pavement layer. The thermographic device includes a housing in which a detection unit for detecting a thermographic data record and a further detection unit for detecting a space-related data record for the thermographic data record are disposed.

### SUMMARY OF THE INVENTION

It is an object according to the invention to provide a method and apparatus that in reliable manner can improve quality of the newly produced asphalt pavement, as defined in claims 1 and 13.

Thanks to the invention it is achieved a method and apparatus by means of which it is possible to produce an asphalt pavement that has an improved quality due to supplying and distributing the asphalt to the paving machine in a state that is considerably much more homogenous than prior art methods/apparatuses. By rotating the rotary vessel including its content of asphalt, the asphalt is made more homogenous, whereby the sensitivity to formation of tracks in the pavement is reduced and likewise also quality defects caused by the batchwise supply of asphalt to the rotary vessel.

Suitably, the rotary vessel generally has the shape of a truncated cone converging downward and having a substantially vertical symmetry axis, and the rotary vessel is rotated around the symmetry axis. Such a shape makes it easy to charge, rotate and empty the vessel.

To assist in the homogenization caused by the rotation, the rotary vessel suitably has an inside wall having irregularities, which as an example may be formed by folded subplate members that constitute the inside wall. Alternatively, the irregularities may be formed by engagement members, e.g. ribs protruding from the inside wall.

The method may be further improved by rigidly attaching a skirt to the frame to protect and insulate to an upper outer side of the rotary vessel.

When making an asphalt pavement with conventional technology, the pavement quality on the left-hand side often differs from that on the right-hand side. To at least reduce this difference, it is preferred to provide a distributing device positioned under the bottom outlet and adapted to be located above the belt conveyor. Suitably, the distributing device has a width that substantially corresponds to a diameter of the outlet of the rotary vessel, and a length that is adapted to be a good fit within the inlet space of the paving machine.

The distributing device preferably comprises:
two parallel outer frame members extending in the feed direction of the belt conveyor; and
a plurality of parallel dividing members spaced from one another and extending transversely from one outer frame member to the other, the dividing members being adapted to be spaced from the belt conveyor by gaps of different size, the size of the gaps increasing in the feed direction of the belt conveyor.

Tests have indicated that an improvement of about 20% is well within reach by means of the invention, which implies enormous savings due to the fact that the life time of the pavement will be prolonged proportionally.

An additional improvement may be achieved in that the distributing device in the feed direction of the belt conveyor has a downstream end, and at said end a rearrangement device for redistributing the asphalt carried as a layer on the belt conveyor, so that the asphalt layer on leaving the distributing device is cambered. The final rearrangement device will create a form of the bed of asphalt leaving it, such that it minimizes, preferably eliminates, slipping of parts of the bed of asphalt, e.g. by creating sides that do not slope more than 45°.

Further advantages and preferred embodiments according to the invention will be described in the following detailed description of the invention, which shall not be construed to have any limiting effect in relation to the scope of claims. As is evident for the skilled person the basic principles according to the invention may be used in a variety of actual method steps.

### BRIEF DESCRIPTION OF THE DRAWINGS

In the following, the invention will be described in more detail with reference to preferred embodiments and the appended drawings wherein

FIG. 1 is a schematic perspective view of a known pavement machine, i.e. a road finishing machine,

FIG. 2 shows a schematic perspective view of the pavement machine of FIG. 1 arranged in accordance with the invention, including a preferred embodiment of supply arrangement in accordance with the invention,

FIG. 3 shows a schematic perspective view of a preferred embodiment of the supply arrangement in accordance with the invention, seen from behind,

FIG. 4 shows a schematic perspective view of a preferred embodiment of the supply arrangement in accordance with the invention, seen from the front,

FIG. 5 shows a schematic perspective view of a preferred embodiment of the supply arrangement in accordance with the invention, seen from above,

FIG. 6 shows a vertical cross-sectional view through a preferred embodiment of the bearing and annular gear in accordance with the invention,

FIG. 7 shows a plan view of a preferred embodiment of a distributing device in accordance with the invention, and,

FIG. 8 shows a vertical cross-sectional view through the distributing device of FIG. 7.

### MODE(S) FOR CARRYING OUT THE INVENTION

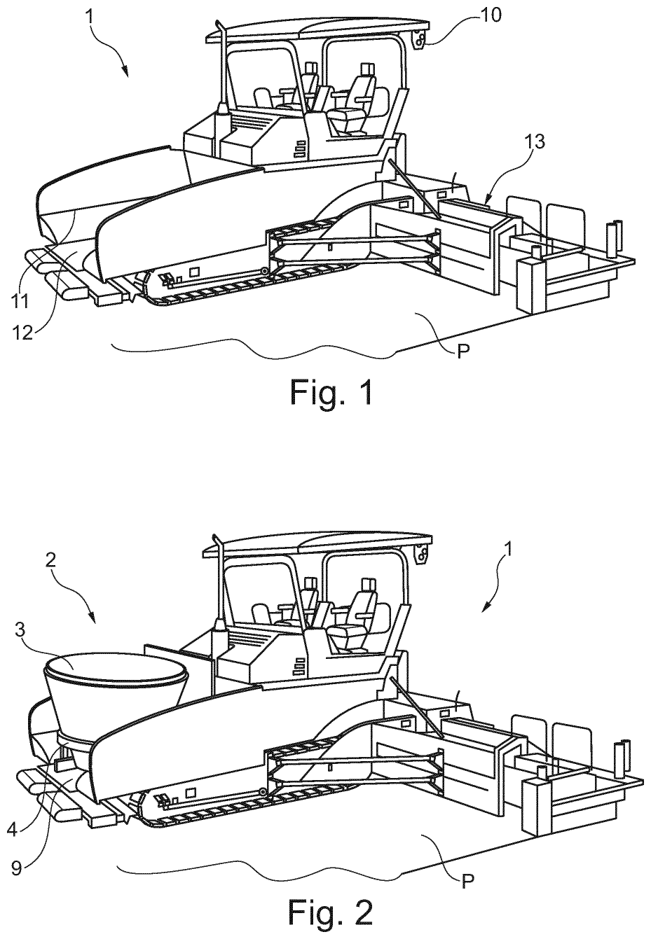

In FIG. 1 there is shown a road finishing machine 1, preferably provided with a sensor 10 for scanning the temperature of an asphalt pavement P directly after laying of the asphalt pavement. The sensor 10 preferably is in form of line scanner that measures the IR radiation. In the preferred embodiment, the line scanner 1 is connected to a quality measurement system as disclosed in WO2016198333, which is herewith introduced by way of reference.

Further the pavement machine has an inlet space 11 for supply of asphalt, e.g. from a truck (not shown). In the bottom of the inlet space 11 there is a belt conveyor 12 or two parallel belt conveyors 12 that feed the asphalt to the screed 13 of the pavement machine, whereby asphalt is distributed to form a pavement P. The screed 13 distributes the asphalt widthwise and levels and shapes it, and it usually includes leveling arms, moldboard, end plates, burners, vibrators, and slope sensors and controls.

In FIG. 2, there is shown a pavement machine 1 of FIG. 1 provided with a supply arrangement 2 in accordance with the invention. Accordingly, the supply arrangement 2 is intended to be used in connection with already existing pavement machines 1, but may of course also be used in connection with new kind of pavement machines. As is evident from the following the supply arrangement 2 preferably is arranged with devices (see items 30, 45, 46) that will facilitate shifting of the supply arrangement 2 from one place to another, e.g. different pavement machines 1.

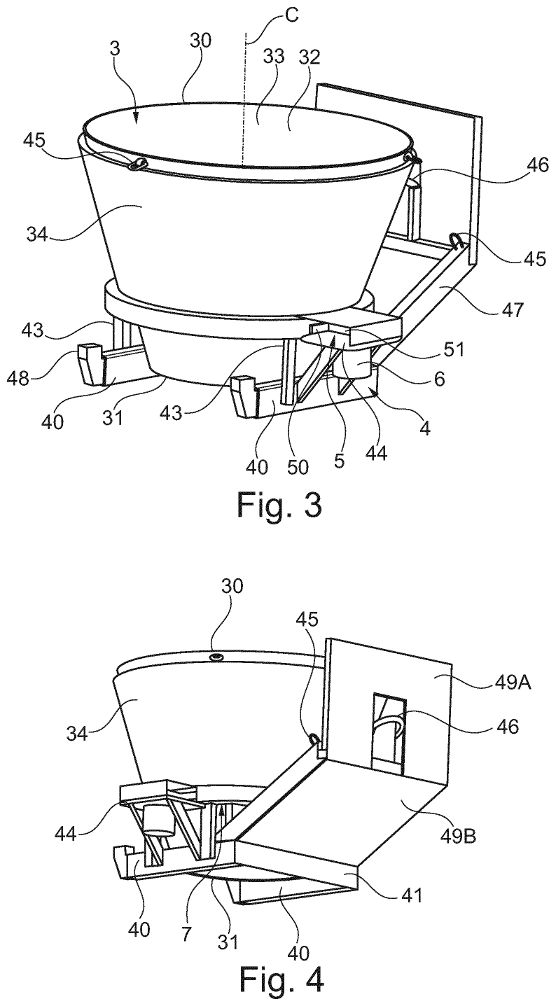

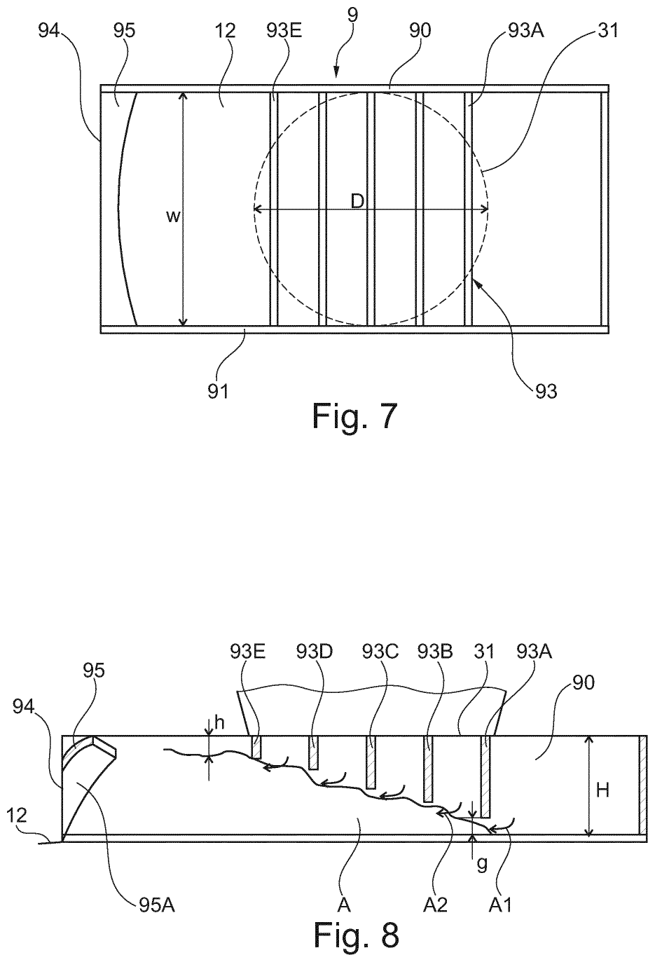

The supply arrangement 2 comprises a conical rotary vessel 3, a frame 4, rotatably supporting the rotary vessel 3, and as shown in FIGS. 3 and 4, a bearing arrangement 7, a transmission 5, and a motor 6 for enabling rotation of the rotary vessel 3. Below the rotary vessel 3 there is a distributing device 9, shown in FIGS. 7 and 8, for optimizing the distribution of asphalt supplied by the feeding arrangement conveyor 12.

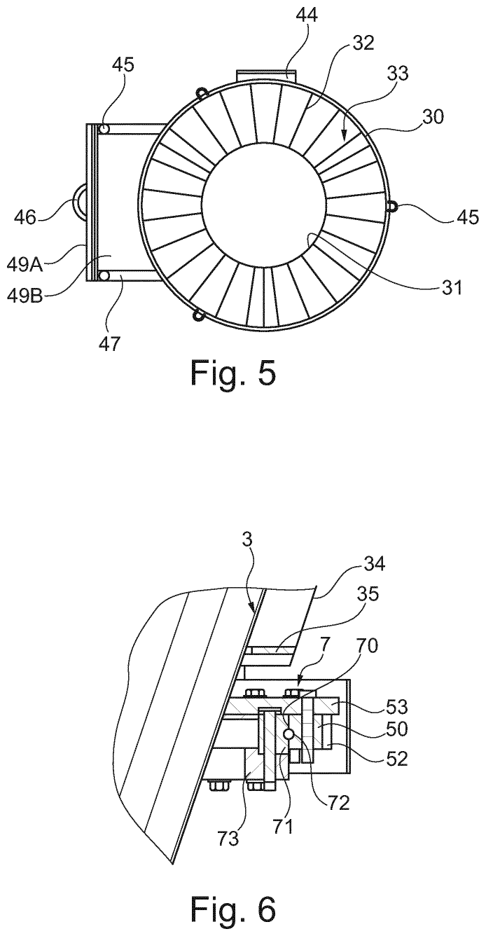

As shown in FIGS. 3, 4 and 5 the rotary vessel 3 generally has the form of a truncated cone that has a substantially vertical rotation axis C and a larger opening at the top forming an inlet 30 and a smaller opening 31 at the bottom forming an outlet. Preferably the inner side of the vessel 3 has some kind of irregularities 32, providing a kind of engagement to the asphalt within the vessel 3 to improve a mixing effect. In the preferred embodiment, these irregularities 32 are formed by folded subplate members 33. In this manner, there is formed a kind of valleys between plate members assisting in providing a kind of engagement to asphalt within the vessel 3. It is evident for the skilled person that many different kind of engagement members 32 may be used, e.g. protruding ribs, etc.

At the upper outer side of the vessel 3 there is a skirt 34 that is rigidly attached to the frame 4 and that provides protection and insulation.

The transmission 5 includes an annular gear 50 that is rigidly connected to the rotary vessel 3 and in meshing engagement with a drive gear 51 driven by the motor 6.

The frame 4 includes three connected base beams, i.e. two parallel side beams 40 and one transversal beam 41 at the front. Extending upwardly from the base beams 40, 41 there are a plurality of support beams 43, supporting a fixed part 73 of a bearing and also a support platform 44 for the motor 6 and drive gear 51. A forwardly extending frame part 47 carries lifting eyelets 45 or similar devices (also preferably provided at the top of the rotary vessel 3), a load exchanging member 46 and wall members 49A, 49B. Preferably the side beams 40 are length adjustable by arranging telescopically adjustable beam members 48, which may be adjusted to extend the length of the sides.

In FIG. 6 there is a detailed view of the rotary part of the transmission 5 and the bearing 7. As shown, the annular gear 50 is has an inner side 70 that forms the rotary surface of the bearing 7, in radial sliding (lubricated) contact with the outer surface of a fixed bearing ring 71. Balls 72 take the axial load. The drive gear 51 interacts with the outwardly protruding teeth 52 of the annular gear 50. The annular gear 50 is fixed to a transmission ring welded onto the outer side of the rotary vessel 3. The fixed bearing ring 71 is fixed to bearing part 73, which in turn is fixed to the support beams 43.

At the bottom of the vessel, and in close proximity to the outlet 31, there is provided a distributing device 9. As indicated in FIGS. 7 and 8, the distributing device 9 is intended to be positioned between the outlet 31 and the belt conveyor 12 of the paving machine 1, i.e. between the side beams 41.

The distributing device 9 has a width W that substantially corresponds to the diameter D of the outlet 31 of the vessel 3. The length thereof is adapted to be a good fit within the paving machine 1. The distributing device 9 has two parallel outer frame members 90, 91 extending longitudinally in relation to the paving machine 1, i.e. the feed direction of the belt conveyor 12. A plurality of dividing members 93 are arranged transversely from one side to the other within the distributing device 9, i.e. from one longitudinal frame member 90 to the other 91. Each dividing member 93A-93E has a different height h. At a most upstream position (with reference to the feed direction of the belt conveyor 12) there is a first dividing member 93A having the largest height, h₁. In parallel therewith there are positioned a plurality of further such dividing walls 93B-93E, wherein each dividing wall in the direction towards the discharge end of the conveyor the height h decreases for each dividing wall. In the shown example, there are positioned five such dividing walls 93A-93E, wherein each of said dividing walls is positioned such that it crosses at least a subsection of the circle defined by the outlet 31 from the vessel 3. Accordingly, the total distance between the five dividing walls in the longitudinal direction is substantially the same as or less than the diameter D of the outlet 31. Further, as is shown there is a substantially proportional decrease of the height h in the direction of feeding, such that the first dividing wall 93A has a height h₁ that is 5 times the height h₅ of the final dividing wall 93E. The height h₁ of the first dividing wall 93A will be smaller than height H of the frame members 90, 91, such that there is created a gap g between the lower end thereof and the belt conveyor 12, which gap will get larger and larger in the feeding direction.

Furthermore, at the far end, downstream, of the distributing device 9 there is arranged a rearrangement device 95. The rearrangement device 95 has a concave surface 95A directed “obliquely” against the flow of asphalt that is supplied by means of the belt conveyor 12, forming a kind of roof that is higher at the center than near the sides, so that the asphalt layer on leaving the distributing device 9 is cambered. The rearrangement device 95 will create a form of the bed of asphalt leaving it, such that it minimizes, preferably eliminates, slipping of parts of the bed of asphalt, e.g. by creating sides that do not slope more than 45°. Further the rearrangement device 95 will create a counter pressure that is also beneficial.

The function of the invention is as follows. The supply arrangement 2 is fitted into a paving machine 1, preferably by lifting it into the supply space 11 by use of the lifting eyelets 45. The distributing device 9 may be positioned on top of the conveyor members 12 of the paving machine 1 before or afterward. In any case the rotary vessel 3 and its frame 4 are positioned on top of the distributing device 9 to be positioned as indicated in FIG. 6.

In operation, asphalt will be supplied into the rotary vessel 3 from above, e.g. by means of an intermediate feeder that is supplied from a truck tipping asphalt from its flatbed (not shown), i.e. in a conventional manner for supplying asphalt to the paving machine 1. Thanks to the rotation of the rotary vessel 3, the asphalt supplied will be thoroughly intermixed, whereby temperature differences that have appeared due to the transport and/or storage will be leveled-out. The belt conveyor 12 of the paving machine 1 continuously moves during operation and accordingly will bring along the asphalt A that is supplied on to it via the outlet 31 of the rotary vessel 3. The distributing device 9 will provide for a further leveling out of the asphalt mixture by means of the dividing walls 93. A first volume A₁ will be supplied near the bottom of the distributing device 9 in connection with a first dividing wall 93A adjacent the upstream end of the belt conveyor 12. Thereafter, a second volume A₂ will be added (on top of the first volume A1) that is supplied down between the first dividing wall 93A and the second dividing wall 93B, etc., and moved by the belt conveyor 12 towards the outlet end 94 of the distributing device 9. At the outlet end 94 of the distributing device 9, a final rearrangement device 95 is provided, the rearrangement device 95 will create a form of the bed of asphalt leaving it, such that it minimizes, preferably eliminates, slipping of parts of the bed of asphalt, e.g. by creating sides that do not slope more than 45°. Further the rearrangement device 95 will create a counter pressure that is also beneficial. Thanks to the invention very much more evenly distributed asphalt will be supplied to the paving machine 1, which will improve the quality of the asphalt.

Tests have indicated that an improvement of about 20% is well within reach by means of the invention, which implies enormous savings, due to the fact that the life time of the pavement will be prolonged proportionally.

The invention is not limited to what is defined above but may be varied within the scope of the claims. For instance, it is evident that a pavement machine 1 without sensor 10 and without a distributing device 9 may be used to achieve the basic advantages of the invention. Moreover, the skilled person realizes that in some applications in may be sufficient to use merely one dividing member 93 arranged transversely from one side to the other within the distributing device 9, and in others two or three or perhaps more than five. Further it is to be understood that the rearrangement device 95 may be positioned adjacent the outlet end 94 or anywhere between the outlet end 94 and the position for the outlet. Moreover, it is evident that many of the expression used are in no way limiting, e.g. that the relationship value may take other formats than the one exemplified above.

1. A method of producing an asphalt pavement, wherein asphalt is fed to a road finishing machine (1) having an inlet space (11), a screed (13), and a belt conveyor (12) forming a bottom of the inlet space (11) and conveying the asphalt to the screed (13) for leveling the layer of asphalt and partially compacting it to a desired shape, said method comprising:
a) providing a supply arrangement (2) for supplying asphalt to the belt conveyor (12), said supply arrangement (2) being adapted to be fitted in the inlet space (11) and including:
a rotary vessel (3) having a top inlet (30) for receiving the asphalt and a bottom outlet (31) for discharging the asphalt, the bottom outlet (31) being smaller than the top inlet (30);
a frame (4) supporting the rotary vessel (3);
a bearing arrangement (7) carried by the frame (4) and carrying the vessel (3) rotatably;
a motor (6) carried by the frame (4) for enabling rotation of the rotary vessel (3); and
a transmission (5) for transmitting a rotation provided by the motor (6) to the rotary vessel (3);
b) positioning the supply arrangement (2) in the inlet space (11);
c) charging asphalt in the rotary vessel (3),
d) rotating the rotary vessel (3) to homogenize the asphalt as to particle size and temperature; and
e) continuously letting asphalt flow from the bottom outlet (31) of the rotary vessel (3) down onto the belt conveyor (12).

2. A method as claimed in claim 1, wherein the rotary vessel (3) generally has the shape of a truncated cone converging downward and having a substantially vertical symmetry axis (C), and the rotary vessel (3) is rotated around the symmetry axis (C).

3. A method as claimed in claim 2, further comprising improving the homogenization by providing irregularities (32) on an inside wall of the rotary vessel (3), wherein preferably the irregularities (32) are formed by folded subplate members (33) that constitute the inside wall.

4. A method as claimed in any one of claims 1-3, further comprising rigidly attaching a skirt (34) to the frame (4) to protect and insulate an upper outer side of the rotary vessel (3).

5. A method as claimed in any one of claims 1-4, further comprising positioning a distributing device (9) under the bottom outlet (31) and above the belt conveyor (12).

6. A method as claimed in claim 5, wherein the distributing device (9) has a width (W) that substantially corresponds to a diameter (D) of the outlet (31) of the rotary vessel (3), and a length that is adapted to fit within the inlet space (11) of the paving machine (1).

7. A method as claimed in claim 5 or 6, wherein the distributing device (9) comprises:
two parallel outer frame members (90, 91) extending in the feed direction of the belt conveyor (12); and
at least one, preferably a plurality of, parallel dividing member/s (93) extending transversely from one outer frame member (90) to the other (91), the dividing members (93) being adapted to be spaced from the belt conveyor (12) by a gap (g), or gaps (g) of different size, wherein the size of the gaps (g) increasing in the feed direction of the belt conveyor (12);
and the method further comprising:
dividing the flow of asphalt from the bottom outlet (31) into a plurality of layers by making the asphalt pass through passages on each side of the at least one dividing member (93) to the belt conveyor (12); and
feeding the plurality of homogenized asphalt layers on top of one another by the belt conveyor (12).

8. A method as claimed in any one of claims 6-7, further comprising:
providing a rearrangement device (95) for redistributing the asphalt carried as a layer on the belt conveyor (12);
positioning the rearrangement device (95) at a downstream end (94) of the distributing device (9); and
using the rearrangement device (95) to camber the asphalt layer on leaving the distributing device (9).

9. A method as claimed in claim 8, wherein the rearrangement device (95) has a concave surface (95A) directed against the flow of asphalt that is supplied by means of the belt conveyor (12).

10. A supply arrangement for supplying asphalt pavement, said supply arrangement adapted to be included in an arrangement for supplying asphalt to a road finishing machine (1), said road finishing machine (1) having an inlet space (11), a screed (13), and a belt conveyor (12) forming a bottom of the inlet space (11) and conveying the asphalt to the screed (13), said supply arrangement being adapted to be fitted in the inlet space (11) and comprising:
a rotary vessel (3) having a top inlet (30) for receiving the asphalt and a bottom outlet (31) for discharging the asphalt, the bottom outlet (31) being smaller than the top inlet (30);
a frame (4) supporting the rotary vessel (3);
a bearing arrangement (7) carried by the frame (4) and carrying the vessel (3) rotatably;
a motor (6) carried by the frame (4) for enabling rotation of the rotary vessel (3); and
a transmission (5) for transmitting a rotation provided by of the motor (6) to the rotary vessel (3).

11. A supply arrangement as claimed in claim 10, wherein the rotary vessel (3) generally has the shape of a truncated cone converging downward and having a substantially vertical rotation axis (C).

12. A supply arrangement as claimed in claim 10 or 11, wherein the rotary vessel (3) has an inside wall having irregularities (32), wherein preferably the irregularities (32) are formed by folded subplate members (33) that constitute the inside wall or wherein the irregularities (32) are formed by engagement members.

13. A supply arrangement as claimed in any one of claims 10-12, further comprising a skirt (34) that is rigidly attached to the frame (4) and that provides protection and insulation to an upper outer side of the rotary vessel (3).

14. A supply arrangement as claimed in any one of claims 10-13, further comprising a distributing device (9) located under the bottom outlet (31) of the rotary vessel (3).

15. A supply arrangement as claimed in claim 14, wherein the distributing device (9) has a width (W) that substantially corresponds to a diameter (D) of the outlet (31) of the rotary vessel (3), and a length that is adapted to within the inlet space (11) of the paving machine (1).

16. A supply arrangement as claimed in claim 14 or 15, wherein the distributing device (9) comprises:
two parallel outer frame members (90, 91); and,
at least one, preferably a plurality of parallel, dividing member/s (93) extending transversely from one outer frame member (90) to the other (91), the at least one dividing member (93) being spaced from the belt conveyor (12) to form a gap (g) between it and the belt conveyor (12), preferably a plurality of dividing member (93) of different size, wherein the size of the gaps (g) increase in a feed direction.

17. A supply arrangement as claimed in any one of claims 14-16, wherein the distributing device (9) has a downstream end (94), and that a rearrangement device (95) for redistributing the asphalt is positioned adjacent said end or between said end and the position for said outlet (31).

18. A supply arrangement as claimed in claim 17, wherein the rearrangement device (95) has a concave surface (95A) directed against a flow of asphalt that is moved within distributing device (9) towards the downstream end (94).
